(19) United States
(12) Patent Application Publication
(10) Pub. No.: US 2017/0343801 A1
(43) Pub. Date: Nov. 30, 2017

(54) HEADS-UP DISPLAY FOR A MOTOR VEHICLE

(71) Applicant: VALEO COMFORT AND DRIVING ASSISTANCE, Créteil (FR)

(72) Inventors: Stéphanie Dabic, Creteil (FR); Laëtitia Dumont, Creteil (FR); Michael Irzyk, Creteil (FR); Vincent Delahaye, Creteil (FR)

(73) Assignee: Valeo Comfort and Driving Assistance, Créteil (FR)

(21) Appl. No.: 15/534,329

(22) PCT Filed: Dec. 10, 2015
(86) PCT No.: PCT/FR2015/053421

§ 371 Date: Jun. 8, 2017

(30) Foreign Application Priority Data
Dec. 10, 2014 (FR) 14/02811

(51) Int. Cl. G02B 27/01; G02B 1/18; G02F 1/153; B60K 35/00; G02F 1/163

(52) U.S. Cl. CPC G02B 27/0101; B60K 35/00; G02F 1/163; G02F 1/153; G02B 1/18; B60K 2350/1096; B60K 2350/2039; G02B 2027/0118; B60K 2350/2052

(57) ABSTRACT

The invention relates to a heads-up display (1) comprising —an image generator (3), —a semi-reflecting display area (7) receiving light beams from said image generator (3), —characterized in that the semi-reflecting area (7) comprises at least one opaque portion or can be rendered opaque.

### TECHNICAL FIELD OF THE INVENTION

The invention relates to a head-up display device for a motor vehicle.

### TECHNOLOGICAL BACKGROUND

The invention will have applications, for example, in motor vehicles for informing the users of the vehicle, in particular its driver.

It is known to equip a motor vehicle with a head-up display device, also known as a head-up display or HUD (standing for “Head-Up Display” in English). Such a display is placed in the field of vision of the motor vehicle's driver and displays information relative to the state of the vehicle, the traffic or other things.

This type of head up display device for a motor vehicle makes it necessary to obtain an image with sufficient brightness so that the user, and notably the driver of the vehicle, can see the image sufficiently, and do so in any situation, day or night and according to the meteorological conditions (sunny or cloudy).

Among the possible technologies for forming such an image by means of the head-up display device, the one most used in the prior art is the liquid crystal display technology, notably the TFT-LCD (standing for “Thin-Film Transistor Liquid Crystal Display” in English) These TFT-LCD display screens necessitate, for the display of an image, backlighting generally carried out by a plurality of light emitting diodes or LEDs (LED standing for “Light-Emitting Diode” in English). In this TFT-LCD screen and the backlighting are comprised in an assembly called an image generating device and also known by the English word “imager”.

Downstream of the screen in the direction of movement of the light beams, the head-up display device generally comprises a semi-reflecting lamina and a reflection device with one or more flat or concave mirrors.

The image is displayed through the semi-reflecting lamina and with magnification and/or by transparency beyond the windscreen of the vehicle.

However, for certain applications and/or in certain lighting conditions, the contrast of the displayed image is not optimum.

Moreover, in the near future, there will be automatically driven cars. During journeys, the passenger/driver will therefore have time available for example to read his email or to surf the Internet. However, currently available screens are generally placed on the dashboard, in the middle between the two front passenger seats, which makes it necessary to turn the head for a prolonged consultation and these screens are therefore poorly adapted for prolonged activity in order to consult a display screen.

### PURPOSES OF THE INVENTION

The purpose of the invention is to overcome at least some of the above disadvantages.

In particular, the invention aims to provide a backlighting device making it possible to improve the contrast of the displayed image in certain conditions.

### DESCRIPTION OF THE INVENTION

For this purpose, the invention relates to a head-up display device comprising:
an image generator,
a semi-reflecting display area receiving light beams from said image generator,
   characterized in that the semi-reflecting area comprises at least one portion which is opaque or which can be made opaque.

The use of at least one portion which is opaque or which can be made opaque makes it possible to increase the contrast of the displayed image. In particular, for warning messages, the user can be alerted better. During automatic driving, the user can read the information projected on the semi-reflecting area with improved comfort and without risk of discomfort. Moreover, as the semi-reflecting area is in the field of vision of the user, the latter thus has the use of a large screen without having to take his eyes off the road.

The head-up display device can comprise one or more of the following features taken alone or in combination:

According to one aspect, the semi-reflecting area is formed by a semi-reflecting lamina intended to be placed at the level of the dashboard in front of a windscreen, which makes it possible to shape the lamina as desired.

The semi-reflecting area can be formed by a windscreen of a motor vehicle, so that an individual semi-reflecting lamina is not necessary.

The semi-reflecting area is for example made from an electrochromic glass, which allows control of partial opacity.

The electrochromic glass is for example formed by a sheet of semi-reflecting glass and an electrochromic film stuck on the sheet of glass. This allows adaptation to existing HUDs.

According to another aspect, the display device comprises a control unit configured for commanding the making opaque of the semi-reflecting area on reception of a control signal.

Thus, the opacity is obtained only in the authorized situations, for example during the automatic driving of the vehicle, or necessary situations, for example in cases of warning.

The control signal can be a warning signal.

According to another aspect, the control signal is a signal of a reading mode during automatic driving.

According to yet another aspect, the semi-reflecting area can be made opaque in its entirety.

Then, the semi-reflecting area comprises for example a single portion which is opaque or which can be made opaque, this portion being a proximal portion with respect to a dashboard.

The semi-reflecting area can comprise a self-cleaning coating. In the long term, the deposit of dust which could degrade the legibility of the information projected to the semi-reflecting area is avoided.

Other advantages and features will become apparent on reading the description of the invention and the appended drawings in which:

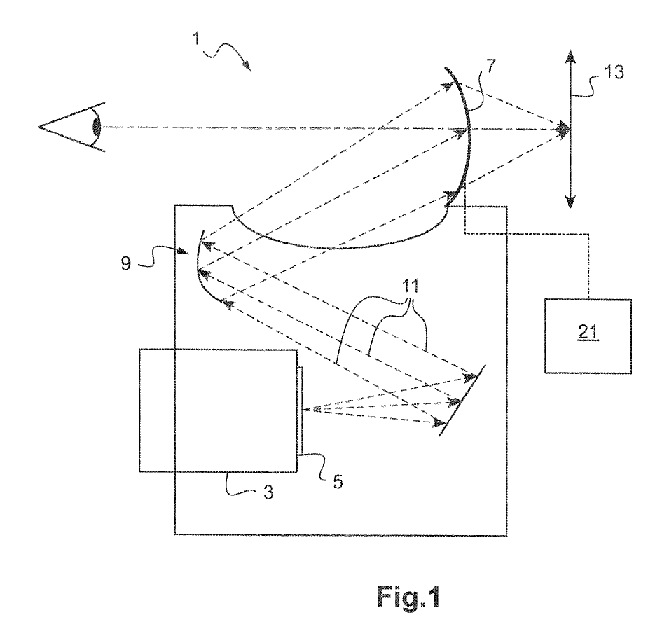

FIG. 1 shows a head-up display device in a diagrammatic manner,

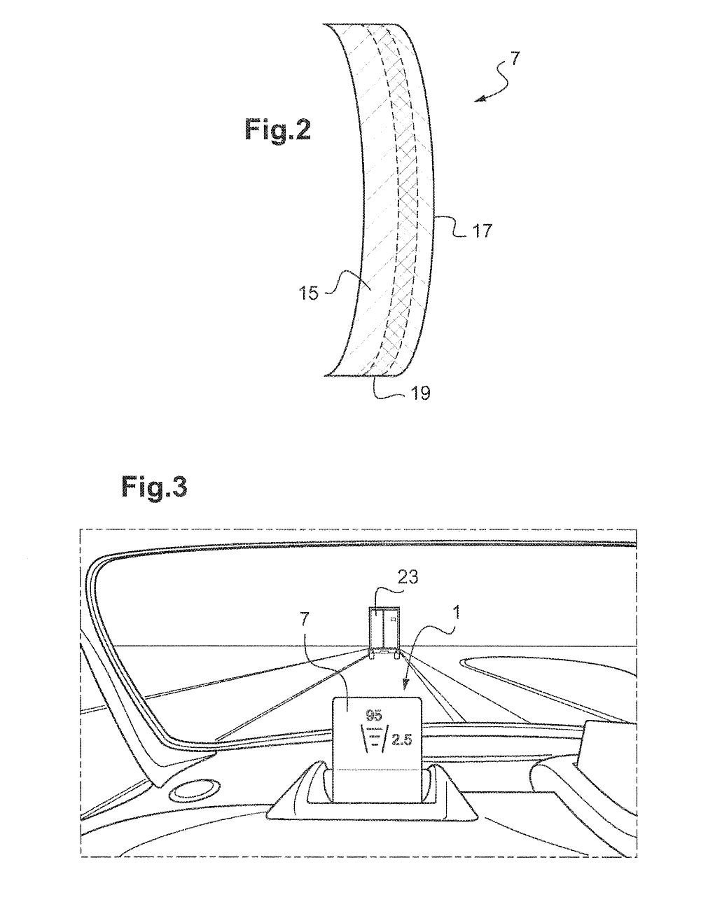

FIG. 2 shows a representation of a semi-reflecting lamina according to a first embodiment in a cross-sectional view,

FIG. 3 shows an image of the display device shown in FIGS. 1 and 2 in operation,

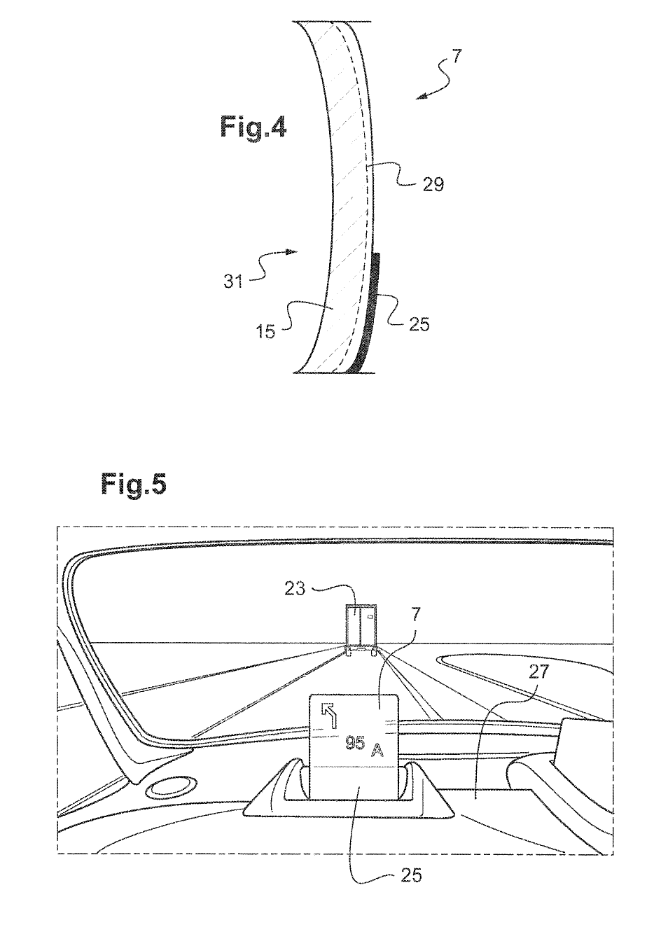

FIG. 4 shows a representation of a semi-reflecting lamina according to a second embodiment in a cross-sectional view,

FIG. 5 shows an image of the display device shown in FIG. 4 in operation.

Identical elements have the same reference numbers in all of the figures.

An example embodiment will now be described with reference to the figures.

The following embodiments are examples. Although the description refers to one or more embodiments, this does not necessarily signify that each reference relates to the same embodiment, or that the features apply solely to a single embodiment. Single features of different embodiments can also be combined in order to provide other embodiments.

FIG. 1 shows a diagram of a head-up display device 1.

This display device 1 comprises an image generating device 3.

This image generating device 3 comprises for example a liquid crystal display screen, in this case a liquid crystal display screen (LCD screen) 5 for example comprising thin film transistors, and an integrated backlighting device (not shown). The liquid crystal display screen 5 can be an active or passive matrix one. The thin film transistor liquid crystal screen 5 is commonly called a TFT-LCD (standing for “Thin-Film Transistor Liquid Crystal Display” in English) screen and allows the formation of an image by the image generating device 3.

The image generating device 3 therefore forms an image with the help of the liquid crystal display screen 5.

Downstream of the screen 5 in the direction of movement of the light beams, the display device 1 comprises at least one semi-reflecting lamina 7, of straight or slightly curved shape in cross-section, and a reflection device 9 interposed in the path of the image between the screen 5 and the semi-reflecting lamina 7, the reflection device 9 comprising one or more flat or concave mirrors, as shown in FIG. 1.

The semi-reflecting lamina 7 forms a semi-reflecting display area receiving light beams from said image generator.

This lamina 7 has for example a reflective power at least equal to 20%, which allows the user to see the road traveled by the vehicle through the lamina whilst allowing him to see the displayed image.

According to a variant which is not shown, it is possible to provide for the semi-reflecting display area to be formed by a part of the windscreen of the vehicle. This would make it possible to save having the semi-reflecting lamina of the head-up display device 1, but would assume that the windscreen has, in the display area, a shape adapted for the display device 1, notably in terms of curvature and a suitable semi-reflective power, for example by applying a semi-transparent film on the windscreen.

In this figure, the path of the image is symbolized by three arrows 11 drawn in dotted line which are reflected on the reflection device 9 before being displayed through the semi-reflecting lamina 7.

The latter makes it possible, via a magnification and/or by transparency, a display of the image beyond the semi-reflecting lamina, notably beyond the windscreen of the vehicle, at the level of a virtual screen 13.

FIG. 2 shows an embodiment of a semi-reflecting lamina 7 in cross-section.

According to this example, the lamina 7 is for example formed by two layers of glass 15 and 17, sandwiching for example a liquid crystal film 19 electrically connected to a control unit 21 in order to be able to control, by application of a suitable electric field orienting the liquid crystals or changing their color, the opacification or not of the lamina 7. It is then said that the semi-reflecting lamina 7 is produced by an electrochromic glass.

In the present invention, the word “glass” equally refers to a silica glass and to a glass for example made of plastic such as crystal polycarbonate.

As a variant, it is possible to use a lamina 7 formed by a single layer of glass upon which is stuck an electrochromic film, for example made white and opaque during the application of an electric current and transparent in the absence of current.

According to the example shown in FIG. 2, the lamina 7 is wholly electrochromic, that is to say it can, according to a control signal from the control unit 21, be made completely opaque.

According to a variant which is not shown, only one part of the lamina 7, for example the lower part, proximal to a dashboard, can be made opaque, for example due to the fact that the liquid crystal film 19 is present only in the lower part of the lamina 7.

The use of at least one portion which is opaque or which can be made opaque makes it possible to increase the contrast of the displayed image and to make the contrast constant. For warning messages in particular, the user can be better alerted. During automatic driving, the user can read the information projected on the semi-reflecting area 7 with increased comfort and without risk of discomfort. Moreover, as the semi-reflecting area 7 is in the user's field of vision, the latter can have the use of a large sized screen without having to turn his head.

The control unit 21 is for example configured for commanding the making of the semi-reflecting lamina 7 opaque on reception of a control signal, such as a warning signal, or a reading mode signal during automatic driving.

Thus, the opacity is only obtained in the authorized situations, for example during automatic driving of the vehicle, or imperative situations, for example in cases of warning.

FIG. 3 shows an image of the display device shown in FIGS. 1 and 2 in operation. In this example, the vehicle has approached too close to a vehicle 23 preceding it. This generates a warning signal which is also transmitted to the control unit 21 making the semi-transparent lamina 7 completely opaque.

Thus the user's attention is drawn by the opacification and due to its opaque appearance the information delivered is more visible, notably with more contrast.

FIG. 4 shows a representation of a semi-reflecting lamina 7 according to a second embodiment in a cross-sectional view.

In this embodiment, the semi-reflecting lamina 7 comprises a single portion 25 which is permanently opaque or which can be made opaque, this portion 25 being a proximal portion with respect to a dashboard 27 of the vehicle.

This can be produced for example by a black film affixed over the portion 25 on the rear surface 29 of the semi-reflecting lamina 7.

FIG. 5 shows an image of the display device according to the embodiment shown in FIG. 4 in operation. Whilst the semi-reflecting portion of the lama 7 indicates for example a direction to follow to the driver, the lower portion 25 indicates the arrival of an email with good contrast.

Moreover, the semi-reflecting lamina 7 can comprise a self-cleaning coating on its front surface 31 receiving the light beams.

Thus, in the long term, the deposit of dust which can degrade the legibility of the information projected to the semi-reflecting zone 7 is avoided.

It can therefore be understood that the comfort of the user can be significantly improved by the fact of at least partly opacifying the semi-reflecting lamina 7 preventing him from discomfort whilst reading on the head-up display device 1 and drawing his attention in dangerous driving situations.

1. A head-up display device comprising:
an image generator; and
a semi-reflecting display area receiving light beams from said image generator,
wherein the semi-reflecting area comprises at least one portion which is opaque.

2. The display device as claimed in claim 1, wherein the semi-reflecting area is formed by a semi-reflecting lamina configured to be placed at the level of the dashboard in front of a windscreen.

3. The display device as claimed in claim 1, wherein the semi-reflecting area is formed by a windscreen of a motor vehicle.

4. The display device as claimed in claim 1, wherein the semi-reflecting area is made from an electrochromic glass.

5. The display device as claimed in claim 4, wherein the electrochromic glass is formed by a sheet of semi-reflecting glass and an electrochromic film stuck on the sheet of glass.

6. The display device as claimed in claim 4, further comprising a control unit configured for commanding the making opaque of the semi-reflecting area on reception of a control signal.

7. The display device as claimed in claim 6, wherein the control signal is a warning signal.

8. The display device as claimed in claim 6, wherein the control signal is a signal of a reading mode during automatic driving.

9. The display device as claimed in claim 1, wherein the semi-reflecting area is entirely opaque.

10. The display device as claimed in claim 1, wherein the semi-reflecting area comprises a single portion which is opaque, the portion being a proximal portion with respect to a dashboard.

11. The display device as claimed in claim 1, wherein the semi-reflecting area comprises a self-cleaning coating.
